(19) United States
(12) Patent Application Publication
(10) Pub. No.: US 2019/0015833 A1
(43) Pub. Date: Jan. 17, 2019

(54) ILLUMINATION DEVICE FOR MICROTITER WELL TRAYS, TUBES AND TUBE STRIPS

(71) Applicant: Dexter Magnetic Technologies, Inc., Elk Grove Village, IL (US)

(72) Inventors: Christian Kronshage, Round Lake, IL (US); Christopher A. Ras, St. Charles, IL (US)

(21) Appl. No.: 16/034,787

(22) Filed: Jul. 13, 2018

Related U.S. Application Data
(60) Provisional application No. 62/532,425, filed on Jul. 14, 2017.

(51) Int. Cl. B01L 3/00; F21V 33/00; F21V 15/01; B03C 1/28

(52) U.S. Cl. CPC B01L 3/561; F21V 33/00; F21W 2131/411; B01L 3/5085; B03C 1/288; F21V 15/01

(57) ABSTRACT

An illumination apparatus includes a housing having at least one electrically operated illumination source. The housing has a plurality of openings corresponding in position to each well or tube in a well tray, a tube tray or a tube strip. The illumination source is configured to provide light to each opening. A magnetic separator having well or tube openings therein corresponding in position to a position of each opening in the housing is disposed on top of the housing. The well tray, tube tray or tube strip comprises a plurality of wells or tubes positioned to correspond to each well or tube opening in the magnetic separator.

### CROSS REFERENCE TO RELATED APPLICATIONS

Priority is claimed from U.S. Provisional Application No. 62/532,425 filed on Jul. 14, 2018, which application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of microtiter wells, trays, tubes and tube strips used with a magnetic separator. More specifically, the disclosure relates to devices for enhancing a user's ability to visually determine the amount of separation of a sample obtained by magnetic separation when the sample is disposed in one or more microtiter wells, trays, tubes and tube strips.

Using high gradient magnetic fields for the separation of particles is commonplace in the technical fields of biology, biotechnology, and other bio-medical technology. Target particles, comprising entities such as proteins and the like, may be separated from a solution by a technique known as magnetic separation. The target particles may be suspended in a subnatant fluid. The suspension may be inserted into one or more microtiter wells, tubes, tube trays and/or tube strips. A magnetic separator is disposed proximate the microtiter wells, tubes, tube trays or tube strips and draws the target particles (e.g., in the form of beads) to the side or bottom of the wells or tube structures, so that the subnatant fluid may be removed. With very tight well or tube densities and small well or tube volumes (on the order of 0.05-0.20 mL each), it may be difficult to determine when separation is complete, particularly when such determination is made by visual observation of the wells or tube structures. Additionally, it may be difficult to determine if all of the subnatant has been completely removed.

### SUMMARY

An illumination apparatus according to one aspect of the disclosure includes a housing having at least one electrically operated illumination source therein. The housing has a plurality of openings corresponding in position to each well or tube in a well tray, a tube tray or a tube strip. The at least one illumination source is configured to provide light to each opening. A magnetic separator has well or tube openings therein corresponding in position to a position of each opening in the housing. The well tray, tube tray or tube strip comprises a plurality of wells or tubes positioned to correspond to each well or tube opening in the magnetic separator.

In some embodiments, the electrically operated illumination source comprises at least one of an incandescent light bulb, a halogen incandescent light bulb, a light emitting diode and a laser diode.

In some embodiments, each opening in the housing comprises an individual incandescent light bulb, halogen incandescent light bulb, light emitting diode or laser diode.

In some embodiments, the electrically operated light source comprises a single incandescent light bulb, halogen incandescent light bulb, light emitting diode or laser diode and a plurality of optical fibers optically connected thereto, each optical fiber terminated in one of the openings in the housing.

Other aspects and possible advantages will be apparent from the following description and claims.

### BRIEF DESCRIPTION OF THE DRAWINGS

FIG. 1 shows and example apparatus according to the present disclosure.

### DETAILED DESCRIPTION

An apparatus according to the present disclosure may improve a user's ability to visually or optically evaluate separation of target particles from a subnatant fluid by providing a device to illuminate each well of a multiple-well sample tray, multiple sample tubes, or sample tube strips, in order to provide improved visibility. The improved visibility may enhance evaluation either by human eye for a visual evaluation or for an automated system using optical sensors to determine the extent of target particle separation from a subnatant fluid.

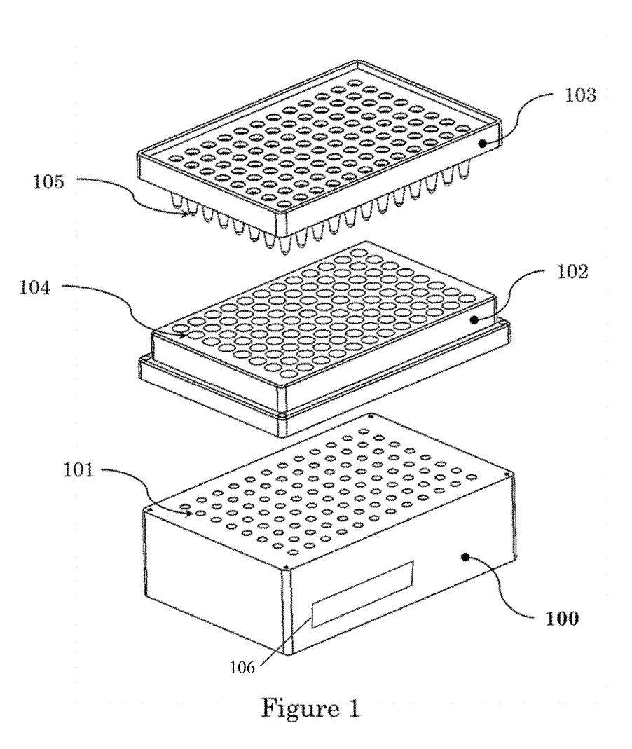

FIG. 1 shows an example embodiment of an apparatus according to the present disclosure. The apparatus includes a housing 100 containing an illumination source 106, e.g., an electrically powered light source and controlling electronics, and means to provide electrical power to the foregoing components. The illumination source 106 may be one or more light emitting diodes (LEDs), ordinary incandescent or halogen incandescent light bulbs, optical fibers terminated at a plurality of positions defined below, one or more laser emitters (e.g., laser diodes), or any other device that produces light when electrical power is supplied to the device.

The top of the housing 100 has openings 101 for light transmission. The openings 101 may align with the locations of each of a plurality of wells 105 in a tray 103 or locations of individual tubes inserted into a tube tray or strip. Each opening 101 may have its own individual illumination source located proximate the bottom of each opening, or a single illumination source may include optical components (e.g., terminated optical fibers) to provide an equivalent illumination source at the location of each opening 101.

Attached to the top of the housing 100, is a magnetic separator 102. The type and configuration of the magnetic separator 102 may be determined by the separation result desired, (e.g., either the bottom or side(s) of the well or tubes). The tray, strip or tubes 103 mount onto the top of the magnetic separator 102. Light is transmitted from the illumination source in the housing 100, through the tube openings 101 in the magnetic separator 102, and into the bottom of each well or tube 105.

Thus illuminated, each tube or well 105 may be visually or optically examined to determine whether full separation of the target particles and/or full removal of the subnatant fluid from each well or tube has occurred.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. An illumination apparatus, comprising:
a housing having at least one electrically operated illumination source therein, the housing having a plurality of openings corresponding in position to each well or tube in a well tray, a tube tray or a tube strip, the at least one illumination source configured to provide light to each opening;
a magnetic separator having well or tube openings therein corresponding in position to a position of each opening in the housing; and
wherein the well tray, tube tray or tube strip comprises a plurality of wells or tubes positioned to correspond to each well or tube opening in the magnetic separator.

2. The apparatus of claim 1 wherein the electrically operated illumination source comprises at least one of an incandescent light bulb, a halogen incandescent light bulb, a light emitting diode and a laser diode.

3. The apparatus of claim 2 wherein each opening in the housing comprises an individual incandescent light bulb, halogen incandescent light bulb, light emitting diode or laser diode.

4. The apparatus of claim 2 wherein the electrically operated light source comprises a single incandescent light bulb, halogen incandescent light bulb, light emitting diode or laser diode and a plurality of optical fibers optically connected thereto, each optical fiber terminated in one of the openings in the housing.
